(19) United States
(12) Patent Application Publication
(10) Pub. No.: US 2005/0241685 A1
(43) Pub. Date: Nov. 3, 2005

(54) Method and apparatus for drying automobile at self-service carwash

(76) Inventor: Gerald James Findley, San Antonio, TX (US)

Correspondence Address: WAYNE J COLTON INC;THE MILAM BUILDING SUITE 1032, 115 EAST TRAVIS STREET, SAN ANTONIO, TX, 78205, US

(21) Appl. No.: 10/836,592

(22) Filed: May 1, 2004

(51) Int. Cl. B08B 3/04

(52) U.S. Cl. 134/123

(57) ABSTRACT

An arrangement for a self-service carwash includes a source of pressurized air; a source of pressurized cleaning fluid; a system of plumbing for interconnecting the source of pressurized air and the source of pressurized cleaning fluid with a spray wand; and a system of valves for alternatively directing either pressurized cleaning fluid or pressurized air through the spray wand. The spray wand includes an adjustable nozzle. The source of pressurized air includes a storage tank, an air compressor or a combination of both. The system of valves is electronically controllable.

### FIELD OF THE INVENTION

The present invention relates to automobile care. More particularly, the invention relates to a self-service carwash having provision for drying as well as washing of an automobile or the like.

### BACKGROUND OF THE INVENTION

Self-service carwashes are popularly provided in nearly every neighborhood of any urban area. While such carwashes provide a convenient location for quickly washing an automobile or the like without the expense of full service carwashes, the heretofore available self-service carwashes make no provision for drying. It is therefore an object of the present invention to improve over the prior art by providing an arrangement for a self-service carwash whereby an automobile or the like may be dried as easily and cost effectively as washed.

### SUMMARY OF THE INVENTION

In accordance with the foregoing objects, the present invention—an arrangement for a self-service carwash—generally comprises a source of pressurized air; a source of pressurized cleaning fluid; a system of plumbing for interconnecting the source of pressurized air and the source of pressurized cleaning fluid with an outlet from the system of plumbing; and a selector, such as a system of valves, for alternatively directing either pressurized cleaning fluid or pressurized air through the outlet.

The outlet may comprise a spray wand, which may have an adjustable nozzle such that higher pressure airflows may be readily achieved as necessary to accomplish drying of an automobile or the like.

The source of pressurized air may comprise a storage tank, an air compressor or a combination of both. The system of valves may include one or more valves, any or all of which may be electronically controllable.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a functional block diagram, the preferred embodiment of the self-service carwash of the present invention; and

FIG. 2 shows, in a table, various options for operation of the self-service carwash of FIG. 1.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

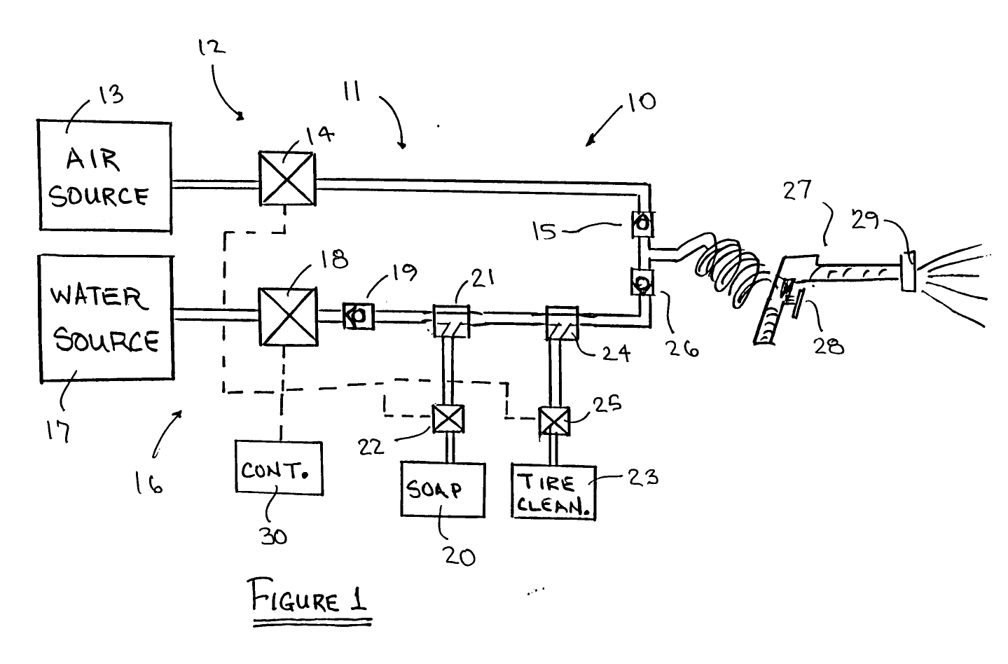

Referring now to FIG. 1 in particular, the self-service carwash arrangement 10 of the present invention is shown to generally comprise an air supply system 12 and a water supply system 16 interconnected through a system of plumbing 11 to a washing and drying wand 27. While the water supply system 16 of the present invention is provided with many of the same features as may be found in conventional self-service carwashes, provisions are made in the water supply system 16 for incorporation into the carwash 10 of the present invention of the air supply system 12. Such provisions will be better understood further herein.

As shown in the figure, the water supply system 16 of the present invention generally comprises a water source 17, such as a city water supply, connected to a preferably electronically controllable supply valve 18 to the washing and drying wand 27. As with conventional carwashes, a soap supply 20 and/or tire cleaner supply 23 may be provided as part of the water supply system 16, in which case a source protection check valve 19 is also preferably provided in order to prevent contamination of the water source 17 from the soap supply 20 or tire cleaner supply 23. As will be appreciated by those of ordinary skill in the art the soap supply 20 connects to the remainder of the water supply system 16 through a soap inlet 21, which may comprise a venturi system, by opening or closing a provided supply valve 22. Likewise, the tire cleaner supply 23 is connected to the water supply system 16 through a tire cleaner inlet 24, which may also comprise a venturi system, by opening and closing a supply valve 25 associated with the tire cleaner supply 23.

Referring still to the figure, the carwash 10 of the present invention comprises the addition of an air supply system 12. As shown, the air supply system 12 generally comprises an air source 13, which may comprise a compressor and/or a storage tank, interconnected to the system of plumbing 11 through a preferably electronically controllable supply valve 14. In this manner, the carwash 10 of the present invention is provided with the capability to dry automobiles as well as wash them. Because, as is shown in the figure, the air supply system 12 is added to work in concert with the water supply system 16, applicant has found it desirable to add also a water isolation check valve 15 in the air supply system 12 to prevent intrusion of water and/or cleaning fluids into the air supply system 12 during washing and/or rinsing cycles of the carwash 10. Likewise, an air isolation check valve 26 is preferably added to the otherwise typical water supply system 16 to prevent intrusion into the water supply system 16 of pressurized air during the added drying cycle of the carwash 10.

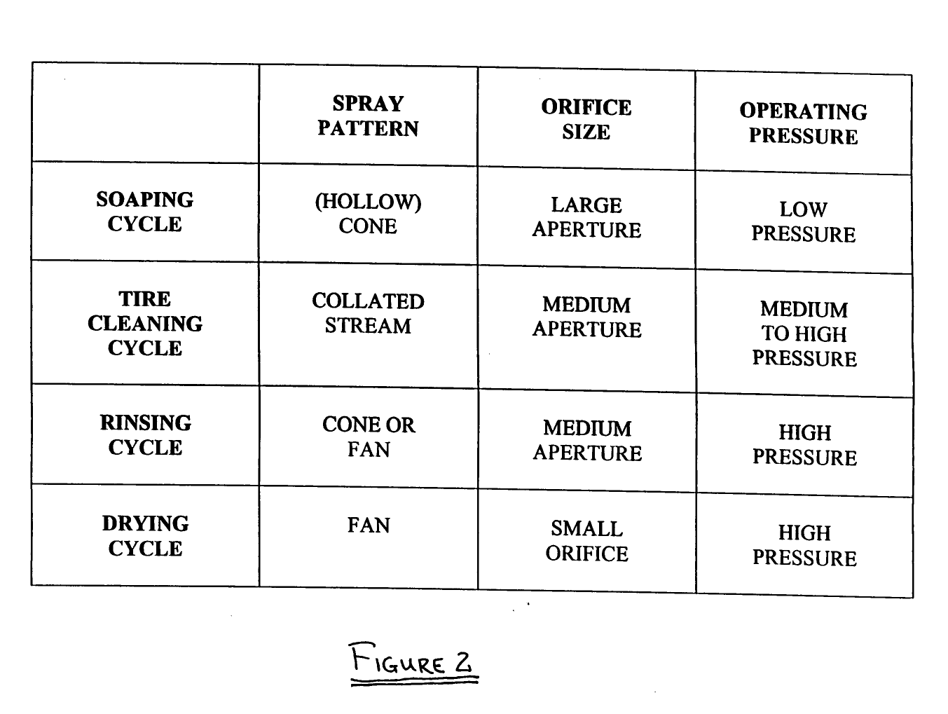

In addition to the provision of check valves 15, 26 isolating the air supply system 12 from the water supply system 16 and vice versa, the applicant has noted that it is desirable to provide the washing and drying wand 27 with an adjustable nozzle 29 such that airflow from the wand 27 may be more readily achieved. To this end the washing and drying wand 27 may comprise any of a variety of available adjustable nozzle systems such as, for example, the rotatably mounted nozzle turret as described in U.S. Pat. No. 6,123,272 issued Sep. 26, 2000 to Havican et al., which, by this reference, is incorporated herein as though now set forth in its entirety. In this manner, any of a variety of settings may be achieved as shown, for example, in the table of FIG. 2.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, the washing and drying wand 27 preferably comprises a control valve 28 for turning on or off the flow of air and/or cleaning fluids from the wand 27 likewise, a controller 30 may be provided to control the various valves 14, 18, 22, 25 of the self-service carwash 10 of the present invention. In any case, because the scope of the present invention is much broader than any particular embodiment, the foregoing detailed description should not be construed as a limitation of the scope of the present invention, which is limited only by the claims appended hereto.

1. An arrangement for a self-service carwash, said arrangement comprising:
a source of pressurized air;
a source of pressurized cleaning fluid;
a system of plumbing for interconnecting said source of pressurized air and said source of pressurized cleaning fluid with an outlet from said system of plumbing; and
a selector for alternatively directing either pressurized cleaning fluid or pressurized air through said outlet.

2. The arrangement for a self-service carwash as recited in claim 1, wherein said outlet comprises a spray wand.

3. The arrangement for a self-service carwash as recited in claim 2, wherein said spray wand comprises an adjustable nozzle.

4. The arrangement for a self-service carwash as recited in claim 3, wherein said adjustable nozzle comprises a variable-size output orifice.

5. The arrangement for a self-service carwash as recited in claim 1, wherein said source of pressurized air comprises a storage tank.

6. The arrangement for a self-service carwash as recited in claim 1, wherein said source of pressurized air comprises an air compressor.

7. The arrangement for a self-service carwash as recited in claim 6, wherein said source of pressurized air further comprises a storage tank.

8. The arrangement for a self-service carwash as recited in claim 1, wherein said selector comprises a valve.

9. The arrangement for a self-service carwash as recited in claim 8, wherein said selector comprises a plurality of valves.

10. The arrangement for a self-service carwash as recited in claim 8, wherein said valve is electronically controllable.

11. The arrangement for a self-service carwash as recited in claim 10, said arrangement further comprising a controller for controlling said selector.
